(19) United States
(12) Patent Application Publication
(10) Pub. No.: US 2008/0003556 A1
(43) Pub. Date: Jan. 3, 2008

(54) Electronic apparatus and wireless connection control method

(75) Inventors: Kei Takahashi, Ome-shi (JP); Kenichi Tonouchi, Ome-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/812,169

(22) Filed: Jun. 15, 2007

(30) Foreign Application Priority Data
Jun. 15, 2006 (JP) 2006-166221

(51) Int. Cl. G09B 5/00

(52) U.S. Cl. 434/307 R

(57) ABSTRACT

According to one embodiment, an electronic apparatus includes an association process performing unit and a password verification unit. The association process performing unit performs an association process to share a unique key between a host device and the electronic apparatus through a wired-connection between the host device and the electronic apparatus. The password verification unit performs a password verification process to determine whether a password stored in the electronic apparatus and a password transmitted from the host device through the wired-connection coincide with each other before the association process is performed, and permits the association process to be performed when both the passwords coincide with each other and inhibits the association process from being performed when both the passwords do not coincide with each other and inhibits the association process from being performed when the both passwords do not coincide with each other.

### CROSS-REFERENCE TO RELATED APPLICATIONS

This application is based upon and claims the benefit of priority from Japanese Patent Application No. 2006-166221, filed Jun. 15, 2006, the entire contents of which are incorporated herein by reference.

### BACKGROUND

1. Field

One embodiment of the invention relates to an electronic apparatus having, for example, a wireless communication function and a wireless connection control method used in the apparatus.

2. Description of the Related Art

Various portable personal computers of a laptop type or a notebook type have recently been developed. Such a computer includes a connection port such as a universal serial bus (USB) interface and an IEEE 1394 interface in order to extend the function of the computer. Different electronic apparatuses each serving as a peripheral device (e.g., a storage device and a printer) can be connected to the connection port.

To connect an electronic apparatus to a portable personal computer via a cable damages the portability of the computer. A new short-range wireless communication system such as a wireless USB standard has recently started to be developed. Jpn. Pat. Appln. KOKAI Publication No. 2004-364256 discloses the configuration of a wireless personal area network including a wireless USB host and a wireless USB device. Under the environment of wireless connection between a computer and various electronic apparatuses, there is possibility that an electronic apparatus of a user will be unauthorizedly accessed by a computer of another user through wireless communication. In the wireless USB standard, a cable association model is prescribed as a procedure for associating the wireless USB host and wireless USB device with each other. Once the wireless USB device is connected to the wireless USB host via a cable, the wireless USB host can wirelessly communicate with the wireless USB device, not through the cable.

Therefore, everybody can freely use the wireless USB device from his or her own computer, if once he or she connects the wireless USB device to his or her own computer via a cable. It is thus necessary to implement a new function of protecting an electronic apparatus such as the wireless USB device from unauthorized use.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary block diagram showing a function structure of an electronic apparatus according to an embodiment of the invention;

FIG. 2 is an exemplary block diagram showing a structure for performing an association process in the electronic apparatus according to the embodiment;

FIG. 3 is an exemplary block diagram showing a hardware structure of a host apparatus which performs communications with the electronic apparatus according to the embodiment;

FIG. 4 is an exemplary block diagram showing a hardware structure of the electronic apparatus according to the embodiment;

FIG. 5 is an exemplary schematic diagram illustrating an association control process used in the electronic apparatus according to the embodiment;

FIG. 6 is an exemplary flowchart illustrating a procedure for an association control process executed by a host apparatus to which the electronic apparatus according to the embodiment;

FIG. 7 is an exemplary diagram showing a password input screen used in the association control process shown in FIG. 6;

FIG. 8 is an exemplary flowchart illustrating a procedure for an association control process executed by the electronic apparatus according to the embodiment;

FIG. 9 is an exemplary flowchart showing a procedure for an authentication process executed by the electronic apparatus according to the embodiment;

FIG. 10 is an exemplary flowchart showing a procedure for a process for allowing or inhibiting wireless communications executed by the electronic apparatus according to the embodiment;

FIG. 11 is an exemplary diagram of the contents stored in a password storage unit provided in the electronic apparatus according to the embodiment;

FIG. 12 is an exemplary flowchart showing a procedure for a password setting/changing process which is performed by the host apparatus connected to the electronic apparatus according to the embodiment;

FIG. 13 is an exemplary diagram showing a password input screen which is displayed by the host apparatus connected to the electronic apparatus according to the embodiment;

FIG. 14 is an exemplary diagram showing a password setting screen which is displayed by the host apparatus connected to the electronic apparatus according to the embodiment; and

FIG. 15 is an exemplary flowchart showing a procedure for a supervisor password verification process which is performed by the electronic apparatus according to the embodiment.

### DETAILED DESCRIPTION

Various embodiments according to the invention will be described hereinafter with reference to the accompanying drawings. In general, according to one embodiment of the invention, an electronic apparatus includes: a wireless communication unit which performs wireless communication; an association process performing unit which performs an association process to share a unique key between a host device and the electronic apparatus through a wired-connection between the host device and the electronic apparatus, when the electronic apparatus is wired-connected to the host device; a storage unit; a password verification unit which performs a password verification process to determine whether a password stored in the storage unit and a password transmitted from the host device through the wired-connection coincide with each other before the association process is performed, and permits the association process to be performed when the password stored in the storage unit and the password transmitted from the host device coincide with each other and inhibits the association process from being performed when the password stored in the storage unit and the password transmitted from the host device do not coincide with each other; and an authentication process performing unit which, when the wireless communication unit detects a host device wirelessly connectable to the wireless communication unit, performs an authentication process to determine whether the host device detected by the wireless communication unit and the electronic apparatus have a same key in common, and permits wireless communication between the wireless communication unit and the host device detected by the wireless communication unit when the host device and the electronic apparatus have a same key in common.

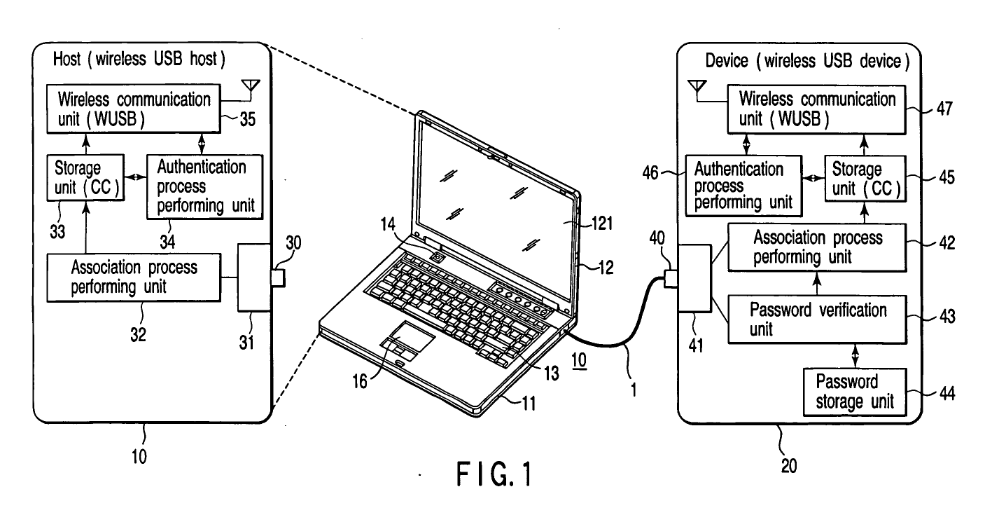

Referring first to FIG. 1, the function structure of the electronic apparatus according to the embodiment of the invention will be described.

The electronic apparatus is implemented as a device 20 capable of wireless communications with a host apparatus. The device 20 serves as a wireless USB device that performs wireless communications with a wireless USB host by the wireless USB standard, for example. For example, the device 20 is a peripheral device such as a storage device and a printer, or an adapter called a device wired adapter (DWA). The DWA is an adapter (hub) for wirelessly connecting the existing wired USB device to the wireless USB host.

The host device 10 also has a wireless communication function and serves as a wireless USB host. For example, the host device 10 is a portable personal computer.

In wireless USB, the wireless USB host can perform wireless communications with 127 wireless USB devices at the maximum.

A device 20 has both a function of being connected to the host device via the existing wired USB interface and a function of being wirelessly connected to the host device via a wireless USB.

The device 20 includes a connection port 40, a wired USB interface 41, an association process performing unit 42, a password verification unit 43, a password storage unit 44, a storage unit 45, an authentication process performing unit 46, and a wireless communication unit 47.

The connection port 40 is configured by, for example, a USB connector. The wired USB interface 41 performs wired-communications with the host device 10 via a USB cable 1. The association process performing unit 42 performs an association process in accordance with a cable association model when the host device 10 is wired-connected to the device 20. The association process is a process for sharing a unique key between the host device 10 and device 20, and it is performed when these devices 10 and 20 are wired-connected via the USB cable 1. The sharing of the unique key allows the devices 10 and 20 to be associated with each other. Needless to say, the association process can be performed when the connection port 40 of the device 20 is physically connected directly to the connection port 30 of the host device 10.

More specifically, in the association process, data is exchanged between the host device 10 and device 20, and connection information called a connection context (CC) is distributed from the host device 10 to the device 20. The CC is stored in the storage unit 45.

The CC is information for associating the host device 10 and device 20 with each other. The CC is included in each of the host device 10 and device 20. The CC has a connection host ID (CHID) which is an identifier (ID) for identifying the host device 10, a connector device ID (CDID) which is an identifier (ID) for identifying the device 20, and a connection key (CK). The CK is the above-described unique key shared between the host device 10 and device 20 and used to establish a secure wireless connection between the host device 10 and device 20. Each pair of devices 10 and 20 generates a single unique CC. If the device 20 completes the association process for associating with each of a plurality of hosts, a plurality of CCs which are corresponded to the hosts are stored in the storage unit 45.

Once an association process is performed between the host device 10 and device 20, they can communicate with each other wirelessly, not through the cable 1.

Usually, the association process is automatically performed when the device 20 is wired-connected to the host device 10 via the USB cable or the like. Therefore, once an unauthorized person wired-connects the device 20 to his or her won computer, there is danger that the device 20 will be wireless accessed unauthorizedly from the unauthorized person's computer.

In the present embodiment, the device 20 includes the password verification unit 43 in order to prevent the association process from being performed without limitation.

The password verification unit 43 performs a password verification process before an association process is performed if a password (association password) is stored in the password storage unit 44. In the password verification process, the unit 43 compares a password that is transmitted via the USB cable 1 from the host device 10 and an association password that is stored in the password storage unit 44 to determine whether these passwords coincide with each other. If they coincide, the unit 43 permits the association process performing unit 42 to perform an association process. On the other hand, if they do not coincide, the unit 43 inhibits the unit 42 from performing an association process. The password verification process is not performed when no association passwords are stored in the password storage unit 44.

The owner of the device 20 wired-connects the device 20 to his or her own computer via a USB cable or the like and then sets a password to the device 20 using a dedicated utility program, the device 20 can be prevented from being used by another user.

When the wireless communication unit 47 detects a host that can be wirelessly connected to the unit 47, the authentication process performing unit 46 determines whether the detected host device and the device 20 have the same key (CK) in common, or the same CC. If the unit 46 determines that they have the same key (CK) in common, it permits wireless communications to be performed between the detected host device and the wireless communication unit 47. In this case, data which is to be transferred by wireless communication between the host device 10 and device 20 is encrypted using an encryption key which is generated from the CK in the authentication process. If they do not have the same key (CK) in common, the unit 46 inhibits wireless communication from being performed between the detected host device and the wireless communication unit 47.

The wireless communication unit 47 is a wireless communication module that carries out wireless communications with a wireless USB host by the wireless USB standard.

The host device 10 includes a main body 11 and a display unit 12 attached to the main body 11. The display unit 12 incorporates a liquid crystal display (LCD) device 121. On the top surface of the main body 11, for example, a keyboard 13, a power button 14, a touch pad 16 are arranged.

The host device 10 has both a function of wired-connecting to the device 20 via the existing wired USB interface and a function of wirelessly-connecting to the device 20 via a wireless USB interface.

The host device 10 includes a connection port 30, a wired USB interface 31, an association process performing unit 32, a storage unit 33, an authentication process performing unit 34, and a wireless communication unit 35.

In accordance with the above cable association model, the association process performing unit 32 performs an association process for associating with a device (wireless USB) which is wired-connected to the host device 10. In the association process, the unit 32 generates a CC (including a CHID, a CDID and a CK) unique to a combination of the host device 10 and the device, and transmits the CC to the device and stores it in the storage unit 33.

When the wireless communication unit 35 receives a wireless connection request from a device, the authentication process performing unit 34 performs an authentication process to determine whether the device and the host device 10 have the same key (CK) in common, or whether they have the same CC. If the unit 34 determines that the devices have the same key (CK) in common, it permits wireless communications to be carried out between the devices.

The wireless communication unit 35 is a wireless communication module that carries out wireless communications with a wireless USB device by the wireless USB standard.

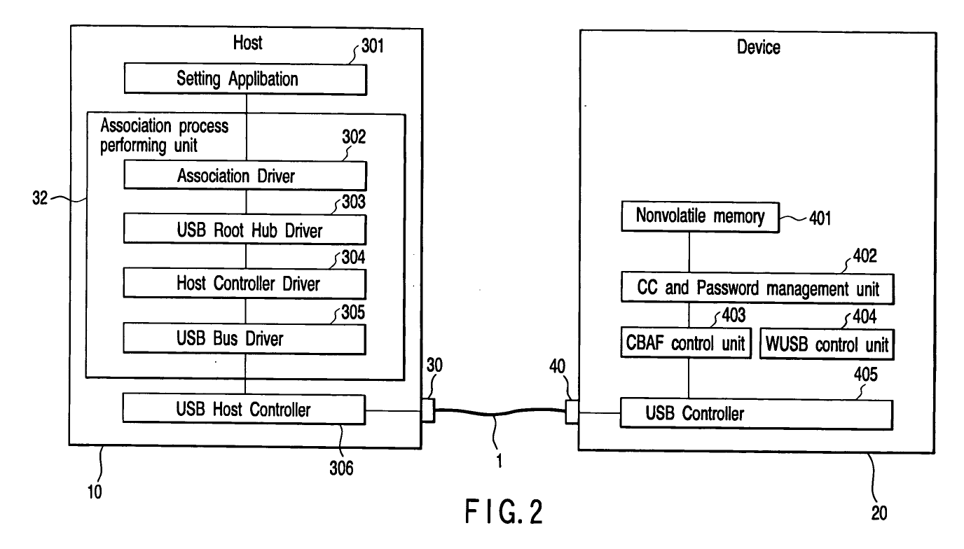

Referring then to FIG. 2, a configuration for achieving the association process used in the present embodiment will be described below.

The association process performing unit 32 of the host device 10 includes an association driver 302, a USB root hub driver 303, a host controller driver 304 and a USB bus driver 305 in order to perform an association process according to the cable model described above. The association driver 302 controls a USB host controller 306 via the USB root hub driver 303, host controller driver 304 and USB bus driver 305 to carry out communications with the device 20 via the USB cable 1. The USB host controller 306 is a controller that performs wired-communications with the USB device via the USB cable 1 and serves as the wired USB interface 31 described above.

The host device 10 includes a setting application 301. The setting application 301 is the above dedicated utility program, and performs a process for setting a password in the device 20, a process for changing the password set in the device 20, and the like. The process for setting a password in the device 20 is performed in the state in which the device 20 is wired-connected to the host device 10 via the USB cable 1 and the like.

The device 20 also includes a nonvolatile memory 401, a CC and password management unit 402, a cable-based association framework (CBAF) control unit 403, a wireless USB (WUSB) control unit 404 and a USB controller 405, in order to perform the association process and the password verification process.

The nonvolatile memory 401 is a storage unit for storing a CC and a password. The CC and password management unit 402 performs a process for storing a CC, which is transmitted from the host device by the association process, in the nonvolatile memory 401 and a process for storing a password, which is transmitted from the host device, in the nonvolatile memory 401 in accordance with a password setting request from the host device.

In order to perform the above association process, the CBAF control unit 403 controls the USB controller 405 and carry out communications with the host device 10 via the USB cable 1. The USB controller 405 is a controller for performing wired communications with the USB host device via the USB cable 1, and serves as the wired USB interface 41 described above.

The WUSB control unit 404 controls the operation of the above wires communication unit 47.

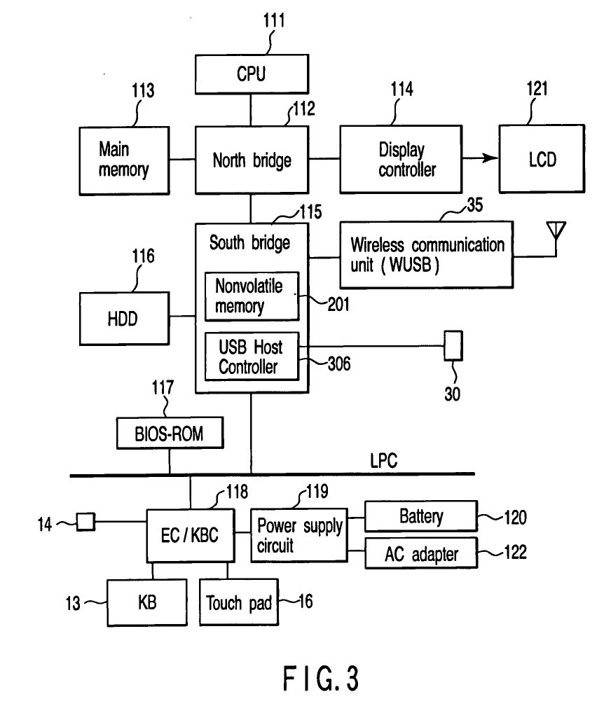

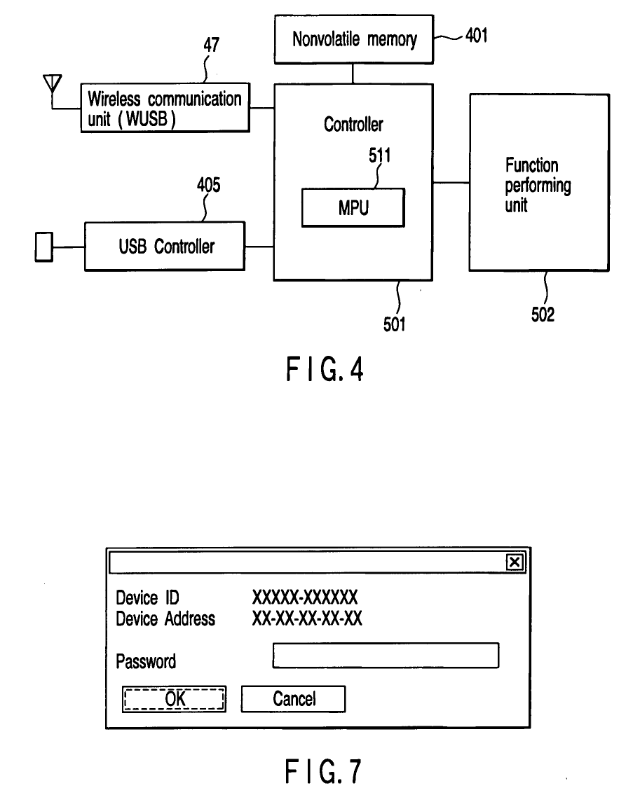

Referring then to FIGS. 3 and 4, a hardware structure of each of the host device 10 and the device 20 will be described with reference to FIGS. 3 and 4.

FIG. 3 shows an example of the hardware structure of the host device 10.

The host device 10 includes a CPU 111, a north bridge 112, a main memory 113, a display controller 114, a south bridge 115, a hard disk drive (HDD) 116, a BIOS-ROM 117, an embedded controller/keyboard controller IC (EC/KBC) 118, and a power supply circuit 119.

The CPU 111 is a processor that controls the operation of each component of the host device 10. The CPU 111 executes an operating system and various application programs/utility programs, which are loaded into the main memory 113 from the HDD 116. The CPU 111 also executes the BIOS stored in the BIOS-ROM 117.

The north bridge 112 is a bridge device that connects the local bus of the CPU 111 and the south bridge 115. The north bridge 112 has a function of communicating with the display controller 114 via an accelerated graphics port (AGP) bus. The north bridge 112 incorporates a memory controller that controls the main memory 113.

The display controller 114 controls the LCD 121 used as a display monitor of the host device 10. The above wireless communication unit 35 is connected to the south bridge 115 via a peripheral component interconnect (PCI) bus or the like. The south bridge 115 incorporates a nonvolatile memory 201 and the USB host controller 306 described above.

The embedded controller/keyboard controller IC (EC/KBC) 118 is a one-chip microcomputer with which an embedded controller for power management and a keyboard controller for controlling the keyboard (KB) 13, touch pad (mouse) 16 and the like are integrated.

The embedded controller/keyboard controller IC 118 cooperates with a power supply circuit 119 and turns on/turns off the host device 10 in accordance with a user's operation of the power button 14. The power supply circuit 119 generates a power that is to be applied to each component of the host device 10 using a power from a battery 120 or an external power from an AC adapter 122.

FIG. 4 shows an example of a hardware structure of the device 20.

The device 20 includes a controller 501 and a function performing unit 502 in addition to the above-described wireless communication unit 47, nonvolatile memory 401 and USB controller 405.

The controller 501 incorporates a microprocessor (MPU) 511, and the MPU 511 controls the wireless communication operation of the wireless communication unit 47 and the wired communication operation of the USB controller 405. The MPU 511 also performs the above-described association process, password verification process, authentication process and the like.

The association process, password verification process and authentication process can be performed by their dedicated hardware.

The function performing unit 502 is a unit for causing the device 20 to function as a peripheral device such as a storage device and a printer, or a DWA.

The outline of the association control process used in the present embodiment of the invention will be described with reference to FIG. 5.

(1) A user connects the host device 10 and device 20 via the USB cable 1. Needless to say, the connection port 40 of the device 20 can be connected directly to the connection port 30 of the host device 10.

(2) When the host device 10 and device 20 are wired-connected to each other, the host device 10 performs a process to confirm that the device 20 supports a cable-based association framework (CBAF).

(3) When the host device 10 confirms that the device 20 supports the CBAF, it performs a process for confirming that the device 20 has a wireless USB structure, using the CBAF.

(4) When the host device 10 confirms that the device 20 has a wireless USB structure, it acquires association information from the device 20 and confirms whether the device 20 has a password protecting function.

(5) When the host device 10 confirms that the device 20 has a password protecting function, it displays on the LCD 121 a password input screen that urges the user to input a password. Needless to say, the device 20 can request the host device 10 to input a password. In reply to the request from the device 20, the host device 10 can display the password input screen on the LCD 121.

(6) and (7) The user types a password on the password input screen. The host device 10 transmits the typed password to the device 20 via the USB cable 1.

(8) The device 20 stands by to receive the password from the host device 10. Upon receiving the password, the device 20 performs a password verification process. If the password is correct, or if the password coincides with an association password set in the device 20, the device 20 notifies the host device 10 that the password is verified in order to allow an association process to be performed.

(9), (10) and (11) The host device 10 and device 20 start to perform a process for sharing a unique key (CK) between the host device 10 and device 20. The host device 10 first transmits a CHID to the device 20. The device 20 searches the storage unit 45 for a CC including the CHID. If the storage unit 45 stores no CC including a CHID, the device 20 transmits a CDID of “0” to the host device 10. The host device 10 creates a new CC, transmits it to the device 20 and stores it in the storage unit 33. The new CC includes a CHID, and a CDID and a CK both created by the host device 10. On the other hand, if the storage unit 45 of the device 20 stores a CC including the CHID transmitted from the host device 10, the device 20 transmits the CDID included in the CC to the host device 10. The host device 10 searches the storage unit 33 for a CC including the CDID transmitted from the device 20. If the storage unit 33 stores the CC including the CDID transmitted from the device 20, the host device 10 updates a CK included in the CC. The host device 10 transmits a CC including the CHID, the CDID and the updated CK to the device 20.

In the present embodiment, a password verification process is performed prior to the performance of an association process for sharing the same CC between the host device 10 and device 20. Unless a password is verified, the association process is not performed. Thus, the host device that can be connected wirelessly to the device 20 can be restricted, and the device 20 can be protected from unauthorized use.

The password verification process has only to be performed when the password protecting function of the device 20 is effective, or when the password is set in the device 20.

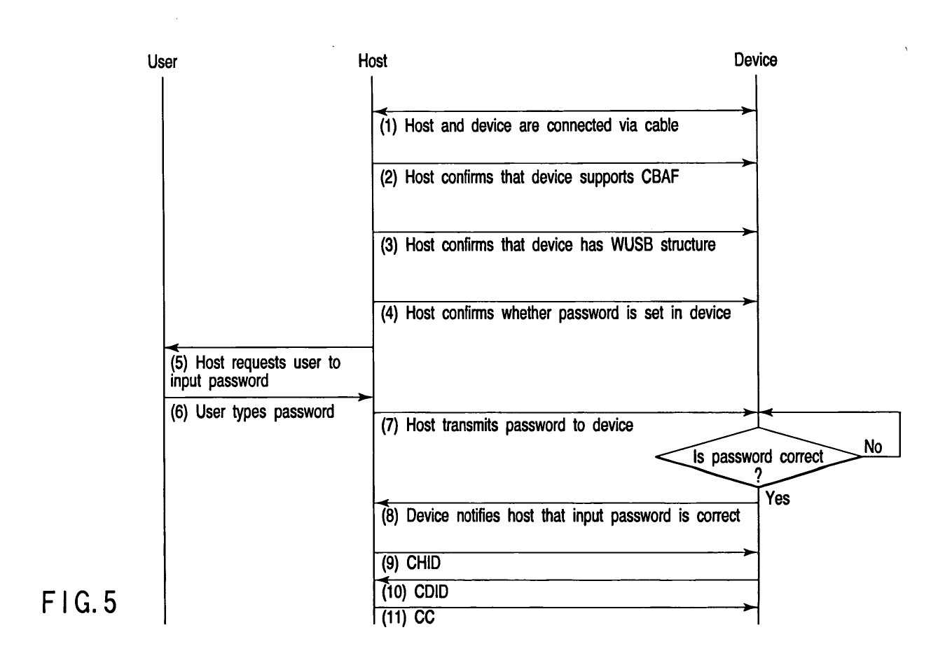

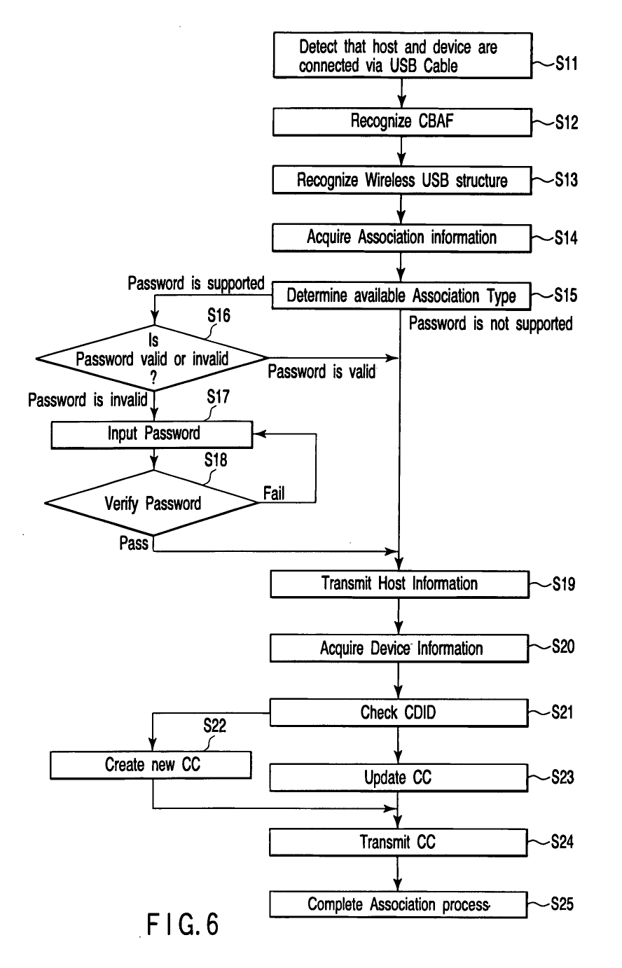

A procedure for the association control process performed by the host device 10 will be described with reference to the flowchart shown in FIG. 6. Assume here that the host device 10 has a structure corresponding to the password protecting function of the device 20.

When the host device 10 detects that the device 20 is connected to the host device 10 via the USB cable 1 (block S11), it confirms whether the device 20 supports the cable-based association framework (CBAF) (block S12). When the host device 10 confirms that the device 20 supports the CBAF, it confirms whether the device 20 has a wireless USB structure (block S13). When the host device 10 confirms that the device 20 has a wireless USB structure, it acquires association information from the device 20 (block S14) and determines an available association type on the basis of the association information (block S15). In block S15, the host device 10 confirms whether the device 20 supports the password protecting function.

If the device 20 supports the password protecting function, the host device 10 determines whether the password protecting function of the device 20 is effective, or whether an association password is stored in the password storage unit 44 of the device 20 (block S16). In block S16, the host device 10 inquires of the device 20 whether the password protection function is effective or not and determines whether an association password is stored in the password storage unit 44 of the device 20. If an association password is stored in the password storage unit 44, the host device 10 displays a password input dialog shown in FIG. 7 on the display screen of the LCD 121 and urges a user to input the password (block S17).

When the user types the password, the host device 10 transmits the typed password to the device 20 and causes the device 20 to perform a password verification process. On the basis of the result of the password verification process transmitted from the device 20, the host device 10 determines whether the password verification process has passed, or whether the typed password coincides with the association password (block S18). When the password verification process has failed, the host device 10 displays the password input dialog shown in FIG. 7 again and urges the user to retype the password.

When the password verification process has passed, the host device 10 transmits host information, which includes a CHID for identifying the host device 10, to the device 20 (block S19).

The device 20 searches the storage unit 45 for a CC including a CHID that coincides with the received CHID. If the CC is stored in the storage unit 45, or if an association process between the host device 10 and device 20 has already been performed, the device 20 extracts the CDID from the CC and transmits device information including the extracted CDID to the host device 10 (block S20). On the other hand, if the storage unit 45 does not store the CC, the device 20 transmits device information, which includes a CDID of “0,” to the host device 10 (block S20).

The host device 10 checks whether the CDID included in the device information transmitted from the device 20 is “0” or not (block S21). If the CDID is “0,” the host device 10 creates a new CC (CHID, CDID, CK) unique to a combination of the host device 10 and device 20 (block S22), and stores it in the storage unit 33 and transmits it to the device 20 (block S23). If the CDID is not “0,” the host device 10 recognizes that an association process between the host device 10 and the device 20 has already been performed. Then, the host device 10 searches the storage unit 33 for a CC corresponding to the device 20, or a CC including a CDID that coincides with the CDID transmitted from the device 20, and updates the CC (block S23). Of the CHID, CDID and CK included in the CC corresponding to the device 20, only the CK is updated in block S23. The host device 10 transmits the updated CC to the device 20 (block S24).

The association control process between the host device 10 and device 20 is thus completed (block S25).

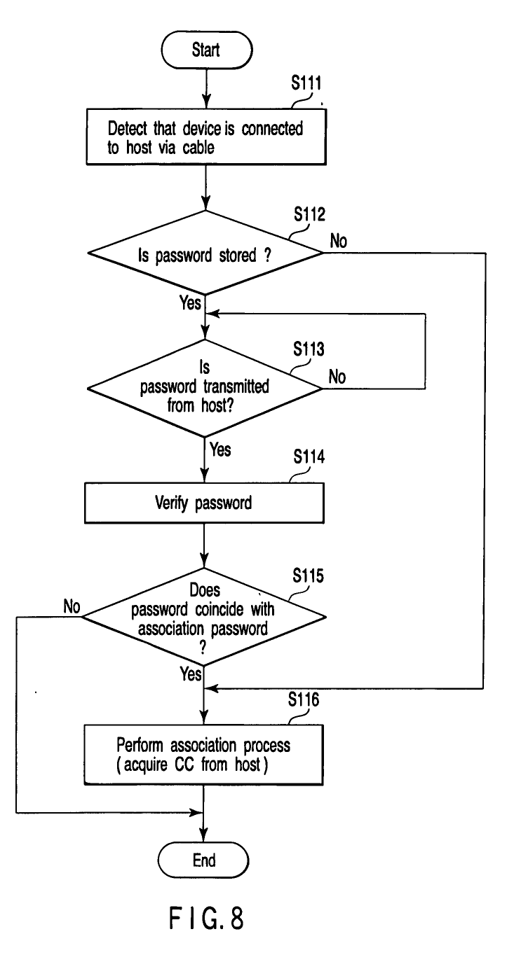

A procedure for the association control process executed by the device 20 will be described with reference to the flowchart shown in FIG. 8.

When the device 20 detects that the device 20 is connected to the host device 10 via the USB cable 1 (block S111), it determines whether the password storage unit 44 stores an association password (block S112).

If the password storage unit 44 does not store the association password (NO in block S112), the device 20 starts an association process to share a CC between the host device 10 and the device 20 under the control of the host device 10 (block S116).

If the password storage unit 44 stores the association password (YES in block S112), the device 20 stands by to receive a password from the host device 10 (block S113). In block S113, the device 20 can request the host device 10 to input a password.

Upon receiving a password from the host device 10 (YES in block S113), the device 20 performs a password verification process (block S114). In block S114, the password verification unit 43 of the device 20 compares the password received from the host device 10 and the association password and determines whether they coincide with each other.

If the password from the host device 10 coincides with the association password (YES in block S115), the password verification unit 43 permits the execution of the association process. Thus, the device 20 starts an association process to share a CC between the host device 10 and the device 20 under the control of the host device 10 (block S116).

If the password from the host device 10 does not coincide with the association password (NO in block S115), the password verification unit 43 inhibits the execution of the association process.

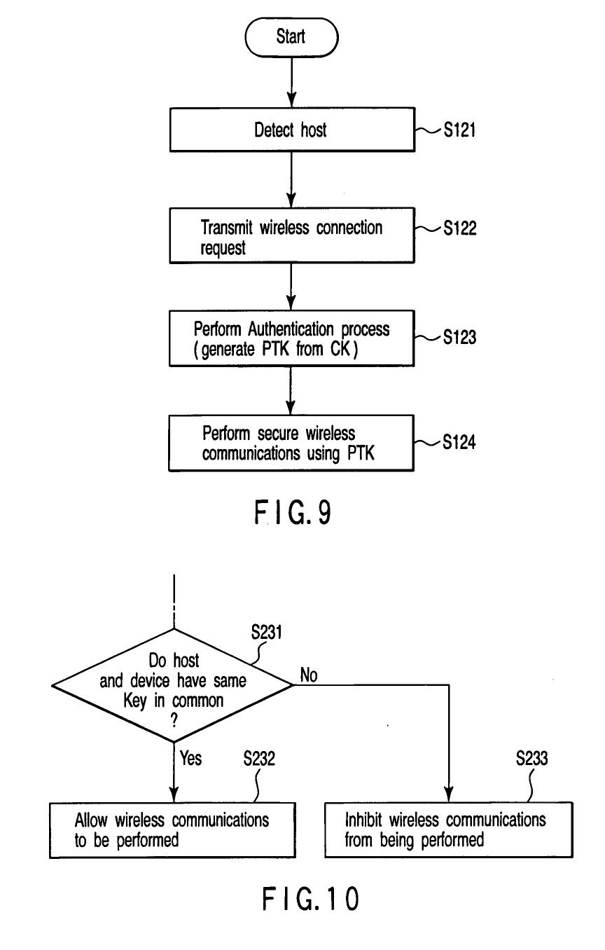

A procedure for the authentication process performed by the device 20 will be described with reference to the flowchart shown in FIG. 9.

When the wireless communication unit 47 detects the presence of the host device 10 (block S121), the device 20 transmits a wireless connection request to the host device 10 through the unit 47 (block S122). In response to the wireless connection request, an authentication process is started, in order to determine whether the host device 10 and device 20 have the same key (CK) in common, or whether they have the same CC in common (block S123). The authentication process is performed by a mutual authentication process called a 4-way handshake. In the mutual authentication process, a process to generate an encryption key called a pair-wised temporal key (PTK) from the CK shared between the host device 10 and the device 20. The PTK is used to encrypt and decrypt data that is transferred by wireless connection between the host device 10 and the device 20.

The device 20 performs secure wireless communications with the host device 10 using the PTK (block S124).

A procedure for the process executed by the authentication process performing unit 46 in block S123 shown in FIG. 9 will be described with reference to the flowchart shown in FIG. 10.

The authentication process performing unit 46 determines whether the host device 10 and the device 20 have the same key (CK) in common (block S231). If the unit 46 determines that they have the same key (CK) in common (YES in block S231), it establishes a wireless connection between the host device 10 and the wireless communication unit 47 and allows wireless communications between them (block S232). If the unit 46 determines that they do not have the same key (CK) in common (NO in block S231), it inhibits wireless communications between them (block S233).

A process for setting/changing a password will now be described.

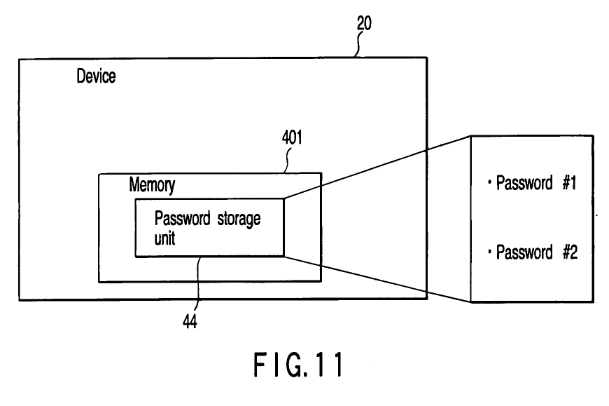

FIG. 11 shows the contents of the password storage unit 44, which are provided in the nonvolatile memory 401 of the device 20. The password storage unit 44 stores two passwords (password #1 and password #2). The password #1 is the above-described association password used to determine whether an association process is permitted or not. The password #2 is a password (supervisor password) used to determine whether to permit a process for setting an association password in the password storage unit 44 and whether to permit a process for changing the association password stored in the password storage unit 44. The use of the supervisor password can prevent the association password from being changed or deleted unauthorizedly.

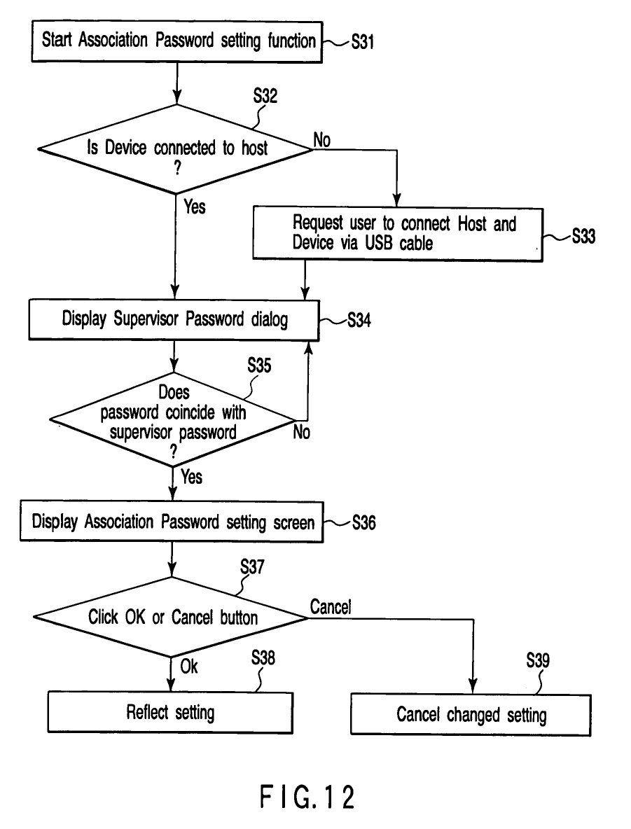

The flowchart of FIG. 12 shows a procedure for setting/changing a password by the setting application 301.

When the setting application 301 is started by a user (block S31), it determines whether the device 20 is wired-connected to the host device 10 via the USB cable or the like (block S32). If the device 20 is not wired-connected to the host device 10 (NO in block S32), the setting application 301 requests the user to wired-connect the host device 10 and the device 20 via the USB cable 1 or the like (block S33).

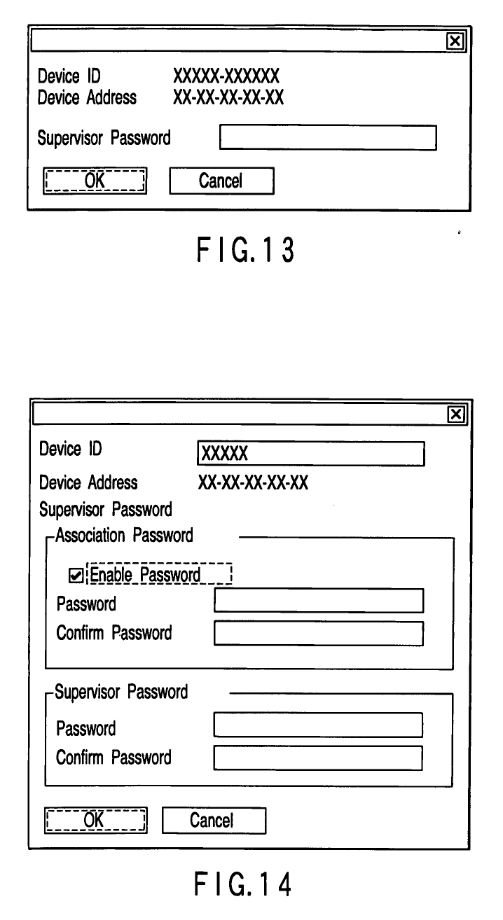

If the device 20 is wired-connected to the host device 10 (YES in block S32), the setting application 301 displays the supervisor password dialog shown in FIG. 13 on the display screen of the LCD 121, and urges the user to input the supervisor password (block S34). When the user types a password to the supervisor password dialog, the setting application 301 transmits the typed password to the device 20 and causes the device 20 to perform a supervisor password verification process. On the basis of the verification of the supervisor password returned from the device 20, the setting application 301 determines whether the user's typed password coincides with the supervisor password stored in advance in the device 20 (block S35). The supervisor password stored in advance in the device 20 is described in, for example, an instruction manual for the device 20. Thus, the owner of the device 20 can type a correct supervisor password.

If the user's typed password coincides with the supervisor password stored in advance in the device 20 (YES in block S35), the setting application 301 displays the password setting screen shown in FIG. 14 on the display screen of the LCD 121 (block S36).

The password setting screen includes a first password input area for setting or changing the association password and a second password input area for changing the supervisor password. If the user clicks an OK button while the association password is typed in the first password input area, the setting application 301 transmits an association password setting request including the typed association password, to the device 20 and causes the device 20 to set or change the association password (block S38). If the user clicks the OK button while the supervisor password is typed in the second password input area, the setting application 301 transmits a supervisor password setting request including the typed supervisor password, to the device 20 and causes the device 20 to change the supervisor password (block S38).

The first password input area includes a check box for indicating the validity/invalidity of the association password. If the user clicks the OK button with the check box unchecked, the setting application 301 requests the device 20 to delete the association password stored in the password storage unit 43 of the device 20.

When the user clicks a cancel button on the password setting screen, no password setting/changing process is performed (block S39).

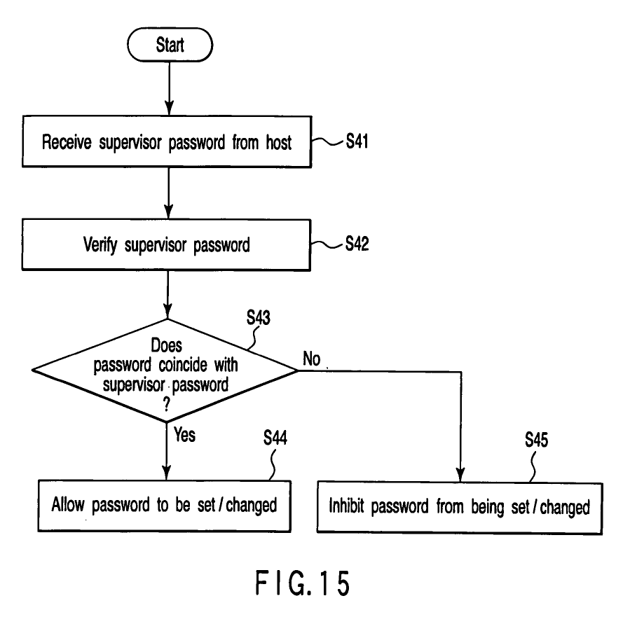

The supervisor password verification process executed by the device 20 will be described with reference to the flowchart shown in FIG. 15.

Upon receiving a supervisor password verification request from the host device 10 (block S41), the CC and password management unit 402 of the device 20 performs a supervisor password verification process (block S42). In block S42, the unit 402 compares a password transmitted from the host device 10 and a supervisor password stored in the password storage unit 44 and determines whether they coincide with each other.

If they coincide with each other (YES in block S43), the CC and password management unit 402 notifies the host device 20 that the supervisor password verification has passed, and permits the host device 10 to set an association password in the password storage unit 44 and change the association password stored in the password storage unit 44 (block S44). On the other hand, if they do not coincide with each other (NO in block S43), the unit 402 notifies the host device 20 that the supervisor password verification has failed and inhibits the host device 10 from setting/changing an association password (block S45).

According to the embodiment of the invention, the control for wireless connection between the host device 10 and the device 20 is carried out by the association process, password verification process, and authentication process. In this case, the association process is performed under the conditions that the device 20 is wired-connected to the host device and a correct password is input by a user. Thus, a host capable of wireless communications with the device 20 can be specified, and any person other than the authorized user can efficiently be prevented from using the device 20 unauthorizedly.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An electronic apparatus comprising:
a wireless communication unit which performs wireless communication;
an association process performing unit which performs an association process to share a unique key between a host device and the electronic apparatus through a wired-connection between the host device and the electronic apparatus, when the electronic apparatus is wired-connected to the host device;
a storage unit;
a password verification unit which performs a password verification process to determine whether a password stored in the storage unit and a password transmitted from the host device through the wired-connection coincide with each other before the association process is performed, and permits the association process to be performed when the password stored in the storage unit and the password transmitted from the host device coincide with each other and inhibits the association process from being performed when the password stored in the storage unit and the password transmitted from the host device do not coincide with each other; and
an authentication process performing unit which, when the wireless communication unit detects a host device wirelessly connectable to the wireless communication unit, performs an authentication process to determine whether the host device detected by the wireless communication unit and the electronic apparatus have a same key in common, and permits wireless communication between the wireless communication unit and the host device detected by the wireless communication unit when the host device and the electronic apparatus have a same key in common.

2. The electronic apparatus according to claim 1, further comprising a password management unit which stores a password transmitted from a host device wired-connected to the electronic apparatus in the storage unit, in accordance with a password setting request transmitted from the host device wired-connected to the electronic apparatus.

3. The electronic apparatus according to claim 2, wherein the storage unit of the electronic apparatus stores another password to determine whether to permit a process for changing the password stored in the storage unit, and
the password management unit determines whether a password transmitted from the host device wired-connected to the electronic apparatus and said another password coincide with each other, and permits the host device wired-connected to the electronic apparatus to change the password stored in the storage unit when the password transmitted from the host device wired-connected to the electronic apparatus and said another password coincide with each other.

4. The electronic apparatus according to claim 1, wherein the storage unit of the electronic apparatus stores another password to determine whether to permit a process for setting a password in the storage unit and whether to permit a process for changing the password stored in the storage unit, and
further comprising a password management unit which determines whether a password transmitted from the host device wired-connected to the electronic apparatus and said another password coincide with each other, and permits the host device wired-connected to the electronic apparatus to set a password in the storage unit and to change the password stored in the storage unit when the password transmitted from the host device wired-connected to the electronic apparatus and said another password coincide with each other.

5. The electronic apparatus according to claim 1, wherein the wireless communication unit performs wireless communication by a wireless USB standard, and
the association process performing unit performs the association process by performing communication between the electronic apparatus and the host device via a USB cable.

6. A wireless connection control method of controlling wireless communication between an electronic apparatus and a host device, comprising:
performing an association process to share a unique key between a host device and the electronic apparatus through a wired-connection between the host device and the electronic apparatus, when the electronic apparatus is wired-connected to the host device;
performing a password verification process to determine whether a password stored in a storage unit provided in the electronic apparatus and a password transmitted from the host device through the wired-connection coincide with each other before the association process is performed;
permitting the association process to be performed when the password stored in the storage unit and the password transmitted from the host device coincide with each other;
inhibiting the association process from being performed when the password stored in the storage unit and the password transmitted from the host device do not coincide with each other;
performing, when the electronic apparatus detects a host device wirelessly connectable to the electronic apparatus, an authentication process to determine whether the host device detected by the electronic apparatus and the electronic apparatus have a same key in common; and
permitting wireless communication between the electronic apparatus and the host device detected by the electronic apparatus when the host device and the electronic apparatus have a same key in common.

7. The wireless connection control method according to claim 6, further comprising storing a password transmitted from the host device wired-connected to the electronic apparatus, in accordance with a password setting request transmitted from the host device wired-connected to the electronic apparatus.

8. The wireless connection control method according to claim 6, wherein the storage unit of the electronic apparatus stores another password to determine whether to permit a process for changing the password stored in the storage unit, and
further comprising:
determining whether a password transmitted from the host device wired-connected to the electronic apparatus and said another password coincide with each other; and
permitting the host device wired-connected to the electronic apparatus to change the password stored in the storage unit when the password transmitted from the host device wired-connected to the electronic apparatus and said another password coincide with each other.

9. The wireless connection control method according to claim 6, wherein the storage unit of the electronic apparatus stores another password to determine whether to permit a process for setting a password in the storage unit and whether to permit a process for changing the password stored in the storage unit, and
further comprising:
determining whether a password transmitted from the host device wired-connected to the electronic apparatus and said another password coincide with each other; and
permitting the host device wired-connected to the electronic apparatus to set a password in the storage unit and to change the password stored in the storage unit when the password transmitted from the host device wired-connected to the electronic apparatus and said another password coincide with each other.

10. The wireless connection control method according to claim 6, wherein the electronic apparatus performs wireless communication by a wireless USB standard, and the performing the association process includes performing the association process by performing communication between the electronic apparatus and the host device via a USB cable.
